(19) United States
(12) Patent Application Publication
(10) Pub. No.: US 2016/0169422 A1
(43) Pub. Date: Jun. 16, 2016

(54) WATER-HOLDING STRUCTURE PUMP TRAP BOND RETROFIT KIT

(71) Applicant: Custom Molded Products, Inc., Newnan, GA (US)

(72) Inventor: Zachary T. Vogtner, Atlanta, GA (US)

(73) Assignee: Custom Molded Products, Inc., Newnan, GA (US)

(21) Appl. No.: 15/050,816

(22) Filed: Feb. 23, 2016

Related U.S. Application Data
(63) Continuation-in-part of application No. 14/527,910, filed on Oct. 30, 2014.

(51) Int. Cl. F16L 13/00; H01R 13/58; H01R 4/02

(52) U.S. Cl. CPC F16L 13/00; H01R 4/023; H01R 13/58

(57) ABSTRACT

A retrofit kit for use with a water-holding structure, the kit having a bonding conductor with a body portion configured to reside within a component attached to the water-holding structure. The bonding conductor includes an extension portion configured to extend outwardly from an outer surface of the component. The retrofit kit includes a strain relief fitting configured to receive the extension portion of the bonding conductor, and to couple with the component attached to the water-holding structure. The retrofit kit also includes a conductor fitting configured to attach to the extension portion of the bonding conductor and to attach to a conductive system of the water-holding structure, providing an electrical connection between the bonding conductor, or the water therein, and the conductive system. The bonding conductor providing equipotential bonding for the water contained in the water-holding structure.

### STATEMENT OF RELATED APPLICATIONS

This application is a continuation-in-part of U.S. patent application Ser. No. 14/527,910 having a filing date of 30 Oct. 2014.

### BACKGROUND OF THE INVENTION

1. Technical Field

This invention relates to kits for use in bonding pool pumps, and more particularly to retrofit kits for use in bonding pool pumps in water-holding structures such as swimming pools, spas, or hot tubs.

2. Prior Art

Some installation codes, including the National Electric Code (NEC), require that water-holding structures, such as a pool, be equipotentially bonded. Equipotential bonding (or “bonding”) for such structures requires permanent joining of metallic parts of the structure to form an electrically conductive path that ensures electrical continuity and the ability to safely conduct any current likely to be imposed. Such bonding establishes equal electrical potential (voltage) in the water-holding structure or pool and ensures that no voltage gradients are present between various areas in or around the pool. By ensuring that the various areas of a pool are at the same electrical potential, the danger of possible electrical shock hazards from stray currents generated by nearby power sources traveling to the pool through the ground or through piping connected to the pool is minimized.

Historically, the pool water was typically bonded to the equipotential grid by running a bonding wire to the metal niche in which a large (8″-12″) light is installed. The metal niches were installed in contact with the water providing the necessary minimum surface area contact (9 square inches) required for the bond. Recently, smaller LED lights have become popular, and many of these do not install with a niche as they can install into a standard plastic wall return fitting. Many pools are built now without any of the larger niche lights, so there is a need for a new way to provide the nine square inches of conductive surface area in constant contact with the pool water. Likewise, as older pools are remodeled to replace older lighting with newer “niche-less” style LED lights, there is a need to invent a retrofit means of providing the nine square inches of conductive surface area in constant contact with the pool water.

Thus, while newer installations of pools or structures are bonded, many older already-existing pools were not. Trying to bond these already-existing pools (or pool components such as pumps, pump traps, skimmers and the like) to meet the codes can be difficult and expensive. Most solutions require replacing a pre-code component, e.g., a pump or pump trap that does not allow for bonding with an entirely new component, e.g., a pump or pump trap that allows for bonding.

Accordingly, it would be desirable to provide a way to retrofit currently installed water-holding structure components, such as pumps, pump traps, skimmers, and the like, to allow for equipotential bonding of the water therein. It is to this need and others that the present invention is directed.

### BRIEF SUMMARY OF THE INVENTION

A retrofit kit for use with water-holding structures such as pools in order to provide equipotential bonding to components of the water-holding structure or to the water therein. An exemplary retrofit kit comprises a bonding conductor with a body portion configured to reside within a component attached to the pool, and in constant contact with the pool water. The bonding conductor also includes an extension portion configured to extend outwardly from an outer surface of the component attached to the pool. The exemplary retrofit kit further includes a strain relief fitting configured to receive the extension portion of the bonding conductor, and to couple with the component attached to the pool, thus holding the bonding conductor in place after installation. The retrofit kit also includes a conductor fitting configured to attach to the extension portion of the bonding conductor and to attach to a conductive system of the pool, providing an electrical connection between the bonding conductor and the conductive system for the pool. The bonding conductor thus provides equipotential bonding for the pool water in contact with said component.

A complete understanding of the present invention may be obtained by reference to the accompanying drawings, when considered in conjunction with the detailed description of preferred embodiments, in which like elements and components bear the same designations and numbering throughout the figures.

### BRIEF DESCRIPTION OF THE DRAWINGS

In the figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a perspective view of an exemplary bonding retrofit kit for use with a water-holding structure.

FIG. 2 is a top view of the exemplary bonding retrofit kit illustrated in FIG. 1, showing an exemplary engagement of the parts of the retrofit kit.

FIG. 3 is a side view of exemplary components of an illustrative pump trap for a water-holding structure with which the retrofit kit of FIG. 1 may be used.

FIG. 4 is a perspective view of the illustrative pump trap of FIG. 3 with a portion of the retrofit kit of FIG. 1 installed.

FIG. 5 is a perspective view of a portion of the pump trap illustrated in FIG. 4 with an additional portion of the retrofit kit of FIG. 1 installed.

FIG. 6 is a side view of an exemplary pump trap of FIG. 3 with the exemplary retrofit kit of FIG. 1 installed.

### DETAILED DESCRIPTION OF PREFERRED EMBODIMENTS

Aspects, features and advantages of several exemplary embodiments of the present invention will become better understood with regard to the following description in connection with the accompanying drawings. It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Any aspect described herein as exemplary is not necessarily to be construed as exclusive, preferred or advantageous over other aspects.

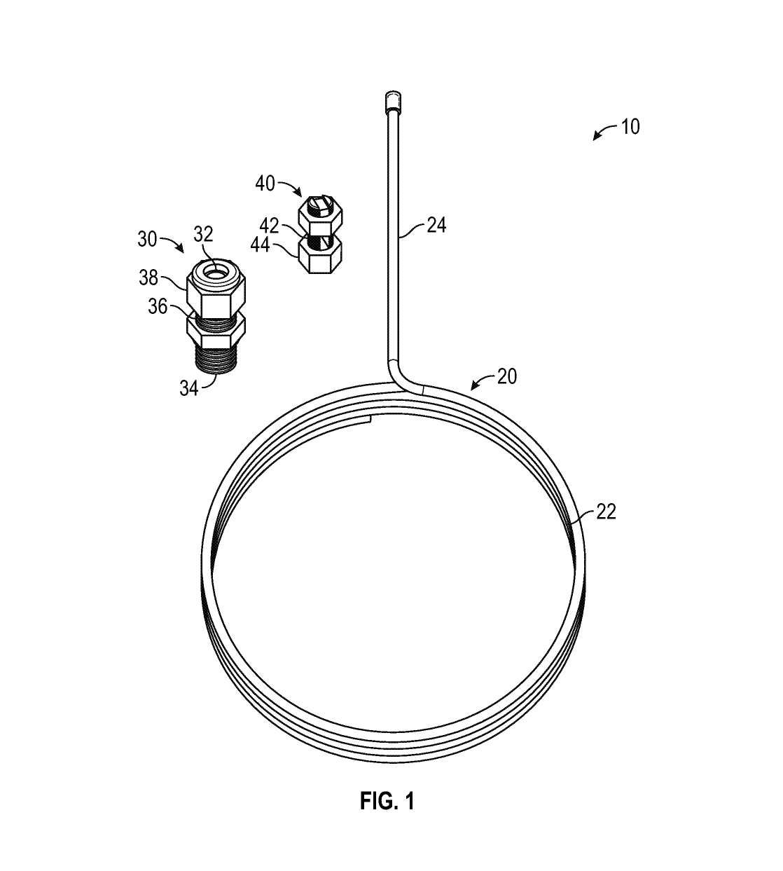

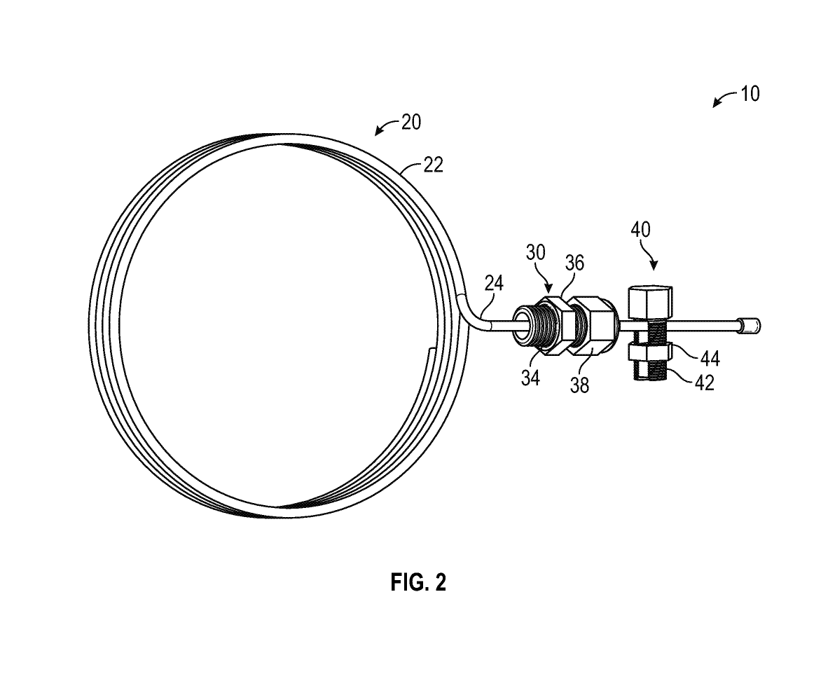

FIGS. 1 and 2 show an exemplary bonding retrofit kit 10 for use with structures for which equipotential bonding is desired is illustrated. FIG. 1 is a perspective view of an exemplary bonding retrofit kit for use with pools. FIG. 2 is a top view of the exemplary bonding retrofit kit illustrated in FIG. 1, showing an exemplary engagement of the parts of the retrofit kit. One such structure for which equipotential bonding is desirable, and in some instances required, is a swimming pool (not shown), and the discussion of the retrofit kit 10 illustrated in FIGS. 1 and 2 will be in terms of use with an pool in order to ease understanding. However, as will be appreciated by one of ordinary skill in the art, the retrofit kit 10 may be used with any desired structure to provide equipotential bonding, for example, to a water-holding structure such as a spa, an aboveground pool, an inground pool, a whirlpool bath, a Jacuzzi® whirlpool bath, a hydromassage unit, a hot tub, fountains, and the like The exemplary retrofit kit 10 illustrated in FIGS. 1 and 2 includes a bonding conductor 20, a strain relief fitting 30, and a split bolt connector 40.

The illustrated bonding conductor 20 comprises a body portion 22 and an extension portion 24 extending from the body portion 22. In the illustrated embodiment, the bonding conductor 20 is formed from a single wire where the body portion 22 comprises a generally circular coil of the wire and the extension portion 24 comprises a straight portion of the wire extending at approximately a right angle from the body portion 22 and being generally coplanar with the body portion 22. Although illustrated as a circular coil, the body portion 22 of the bonding conductor 20 may be any shape desired. Similarly, although illustrated as a generally straight portion extending at a right angle in a coplanar manner from the body portion 22, the extension portion 24 may be configured in any manner desired. One of ordinary skill in the art would understand that such shape and/or manufacture of the bonding conductor 20 could vary depending on the specific component or structure for which the retrofit kit 10 is intended.

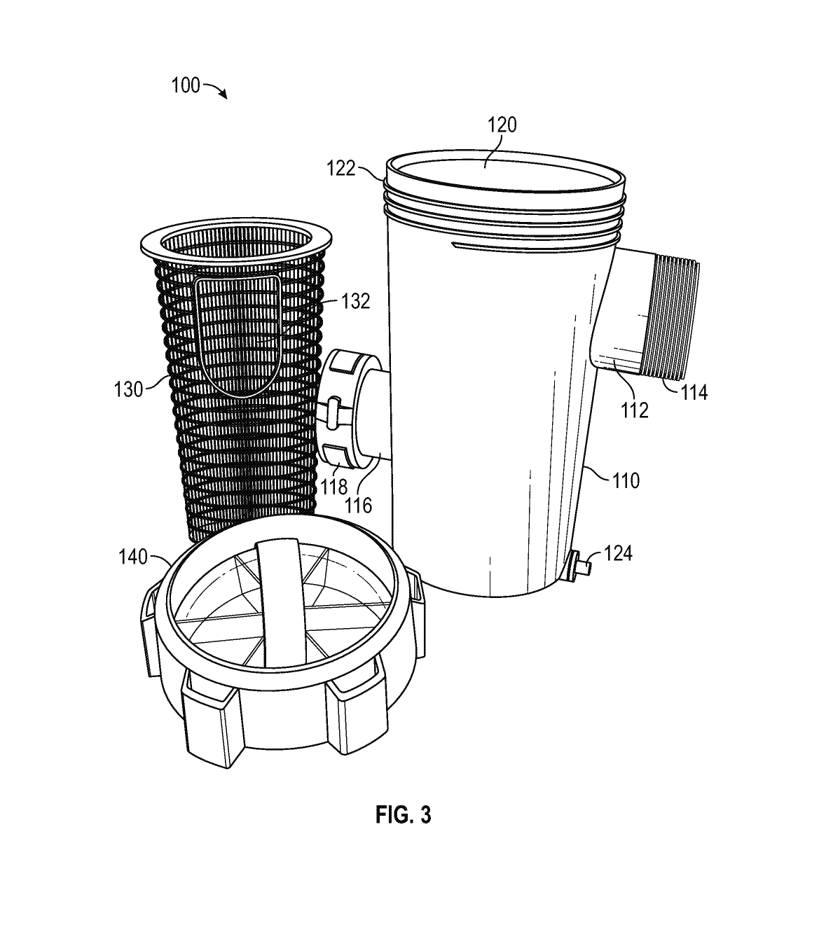

As disclosed herein, the illustrated retrofit kit 10 is dimensioned for use with a swimming pool pump trap that is generally cylindrical in shape (see FIG. 3). For retrofit kits 10 intended for other swimming pool components, or pump traps of differing shape, or other water-holding structures, the body portion 22 and/or extension portion 24 may be shaped or configured differently. Regardless of shape or configuration, it is preferred that the body portion 22 of the bonding conductor 20 comprises at least nine square inches of conductive surface to meet the bonding requirements of the National Electrical Code (NEC).

The exemplary retrofit kit 10 illustrated in FIGS. 1 and 2 also includes a strain relief fitting 30 configured to be coupled with the extension portion 24 of the bonding conductor 20 when installed. The illustrated strain relief fitting 30 is hollow (as illustrated with the top opening 32 that extends all the way through the fitting 30) is and generally cylindrical. The preferred strain relief fitting 30 has an inner diameter and an outer diameter. The outer diameter of the strain relief fitting 30 is dimensioned so as to allow installation of the bonding conductor 20 in the pool component to be bonded. The inner diameter of the strain relief fitting 30 is dimensioned so as to fit around the bonding conductor 20, and to assist in preventing movement of the bonding conductor 20 once installed.

To assist in keeping the bonding conductor 20 in place when installed, the strain relief fitting 30 may include a threaded portion 34 to engage the pool component to hold the bonding conductor 20 in place. The strain relief fitting 30 also may include a connector nut 36 portion configured to allowing tightening of the threaded portion 34 with the pool component to be bonded as disclosed herein. In such embodiments, the connector nut 36 may not be a separate component, but may instead be integrally formed onto the outer surface of the strain relief fitting 30. Alternatively, in other embodiments, the connector nut 36 may be a separate component configured to engage a threaded portion 34 of the outer surface of the strain relief fitting 30. In such embodiments, the connector nut 36 may be used to help hold the installed the bonding conductor 20 in place by tightening the connector nut 36 against the pool component.

To provide further strain relief, the strain relief fitting 30 may also include a hollow cap 38 as illustrated in FIGS. 1 and 2. The hollow cap 38 may be configured to also engage a threaded portion 34 of the outer surface of the strain relief fitting 30. Note that the threaded portion 34 engaged by the cap 38 may be a continuation of the threaded portion 34 discussed above, or a separate threaded portion 34 on the outer surface of the strain relief fitting 30 that is configured to receive the cap 38.

The inner surface of at least the end of the hollow cap 38 is dimensioned so as to fit relatively snugly around the extension portion 24 of the bonding conductor 20. Further, the inner surface of the hollow cap 38 may be comprised of a relatively soft plastic, rubber, elastomer, or other material so as to ensure a snug fit around the extension portion 24 of the bonding conductor 20. When installed on the strain relief fitting 30, such as by engaging the threaded portion 34, the cap 38 may serve to further prevent movement of the installed bonding conductor 20.

Again, the illustrated strain relief fitting 30 is dimensioned and configured to allow use of the retrofit kit 10 with a swimming pool pump trap that is generally cylindrical in shape (see FIG. 3). One of ordinary skill in the art would understand that the dimensions, shape, and/or configuration of the strain relief fitting 30 could vary depending on the specific component or structure for which the retrofit kit 10 is intended.

In the exemplary embodiment illustrated in FIGS. 1 and 2, the retrofit kit 10 also includes a split bolt connector 40 configured to be coupled with the extension portion 24 of the bonding conductor 20 when installed. The preferred split bolt connector 40 is formed from a conductive material and comprises a body portion 42 with a threaded outer surface and a nut portion 44 configured to engage the threaded outer portion of the body portion 42. The split bolt connector 40 may be installed on the extension portion 24 of the bonding conductor 20 once the bonding conductor 20 is installed by inserting the extension portion 24 into the split in the body portion 42 of the split bolt connector 40 and engaging the nut portion 44 with the body portion 42 (see FIG. 2). The split bolt connector 40 then may be coupled to copper or other wire that is coupled at the other end to the swimming pool bonding system. In this manner, the split bolt connector 40 allows the bonding conductor 20 to electrically connect with the bonding system of the swimming pool as needed.

In addition to the different sizes, shapes, configurations, etc., possible for the components of the illustrated retrofit kit 10 depending on the pool component with which the retrofit kit 10 will be used, one of ordinary skill in the art would also understand that the retrofit kit 10 could be comprised of more or fewer components than those shown in FIGS. 1 and 2. For example, not every embodiment of the retrofit kit 10 may require a split bolt connector 40 in order to electrically connect the bonding conductor 20 to a bonding system of the pool. Similarly, in some embodiments, additional components may be part of the retro fit kit 10. One such example would be the inclusion of gaskets, O-rings, or the like in order to ensure a watertight installation of the bonding conductor 20 in some implementations. All such variations of the retrofit kit 10 are within the scope of this disclosure.

The present invention may be used with any structure for which equipotential bonding is desired. As noted, one exemplary structure may be an already installed pool, in-ground or above-ground. For such a pool, the present invention may allow retrofitted bonding for various components, including a pool pump and/or pool pump trap. FIG. 3 is a side view of exemplary components of an illustrative pump trap 100 for a swimming pool in which the exemplary retrofit kit of FIG. 1 can be installed to provide bonding for the pool water.

The exemplary pump trap 100 includes a housing 110 that is generally cylindrical in shape and hollow with a generally round enclosed bottom and a generally round top opening 120. The exemplary housing 110 includes a pipe connector port 112 extending from the outer surface of the housing 110. The pipe connector port 112 is configured to couple to a pipe carrying water from the pool to a pump coupled to the pump trap 100. The pipe connector port 112 may be a generally cylindrical hollow tube formed into, and extending from, the surface of the housing 110 to allow water from the pool into the housing 110. The pipe connector port 112 may be dimensioned as desired in order to allow installation with pools. The outer surface of the end of the pipe connector port 112 distal from the housing 110 may include a threaded portion 114 in order to facilitate coupling the pipe connector port 112 to a pipe carrying water from the pool.

The illustrated housing 110 also includes a pump connector port 116 extending from the outer surface of the housing 110. As illustrated in FIG. 3 the pump connector port 116 may be located on the opposite outer surface from the pipe connector port 112. However, in other embodiments, the pump connector port 116 may be located elsewhere on the housing 110. The pump connector port 116 is configured to couple to a pump, allowing water carried from the pool to the pump trap 100 to be recirculated into the pool by the pump. The pump connector port 116 may be a generally cylindrical hollow tube formed into, and extending from, the surface of the housing 110 to allow water from the housing 110 to pass to the pump (not shown). The pump connector port 116 may be dimensioned as desired in order to allow installation with any desired pump. The end of the pump connector port 116 distal from the housing 110 may include a connector fitting 118 in order to facilitate coupling the pump connector port 116 to the pump.

The illustrated housing also includes a drain hole 124 extending from the outer surface of the housing 110. As illustrated in FIG. 3, the drain hole 124 may be located towards the bottom end of the housing 110, and may be located on the side of the housing 110 opposite of the pump connector port 116. However, in other embodiments, the drain hole 124 may be located elsewhere on the housing 110. The preferred drain hole 124 is a generally round aperture into the housing 110, however other shapes are possible. Additionally, the size of the drain hole 124 may be dimensioned as desired. As illustrated in FIG. 3, the drain hole 124 may be partially sealed with an inserted plug, or the drain hole may be left open. The preferred drain hole 124 illustrated in FIG. 3 has an inner surface that is threaded.

The exemplary pump trap 100 illustrated in FIG. 3 also includes a skimmer or strainer basket 130 that fits inside the housing 110. The strainer basket 130 is generally cylindrical in shape and is hollow with a generally round enclosed bottom and a generally round open top. The strainer basket 130 is dimensioned so as to allow the strainer basket 130 to be inserted into the top opening 120 of the housing 110. The strainer basket 130 also has an inlet opening 132 on one side to receive water from the pool. The inlet opening 132 is dimensioned and configured so as to receive water through the pipe connector port 112 of the housing 110. The surface of the strainer basket 130 contains a plurality of small apertures. In operation, when the strainer basket 130 is inserted into the housing 110, water will flow from the pool through the pipe connector port 112 of the housing 110, and into the strainer basket 130 through the inlet opening 132. The apertures in the surface of the strainer basket 130 allow the water to then flow freely back out of the strainer basket 130, while any debris (such as bugs, leaves, etc.) in the water will remain inside the strainer basket 130. This represents a skimmer structure.

The exemplary pump trap 100 illustrated in FIG. 3 also includes a lid 140 configured to cover the top opening 120 of the housing 110. The illustrated lid 140 is generally round, and dimensioned to fit over the outer surface of the housing 110 to cover the top opening 120 in order the hold the strainer basket 130 in place within the housing 110. The lid 140 may have a threaded inner surface in order to engage the threaded surface 122 on the housing 110 in order to secure the lid 140 to the housing 110. Other mechanisms for securing the lid 140 to the housing 110 may be used instead of, or in addition to, the illustrated threads. The lid 140 may also include a transparent portion in the top of the lid 140 to allow a user to see whether debris has accumulated in the strainer basket 130 within the housing 110.

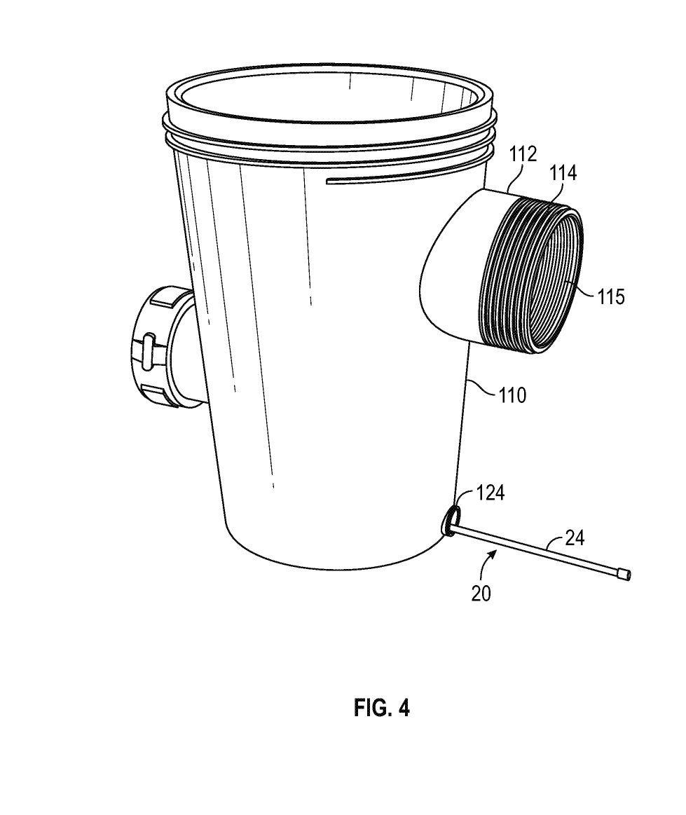

FIGS. 4-6 show various illustrative aspects of use of the exemplary retrofit kit 10 of FIG. 1 with the exemplary pump trap 100 of FIG. 1. In FIG. 4 a perspective view of the exemplary pump trap housing 110 of FIG. 3 with a portion of the retrofit kit of FIG. 1 installed is illustrated. As shown in FIG. 4, the bonding conductor 20 has been placed inside of the housing 110, such that the body portion 22 of the bonding conductor 20 is resting on the bottom inside surface of the housing 110. The extension portion 24 of the bonding conductor 20 has been inserted into the drain hole 124 from the inside of the housing 110, such that the extension portion 24 of the bonding conductor 20 extends outside of the housing 110 through the drain hole 124. The body portion 22 of the bonding conductor 20 has been dimensioned so that it fits within the inner dimension of the housing 110 and rests on the closed bottom of the housing 110. For a differently shaped or configured pump trap 100 or housing 110 than that illustrated in FIG. 3, the bonding conductor 20 of FIG. 1 may also be correspondingly of a different shape and/or configuration.

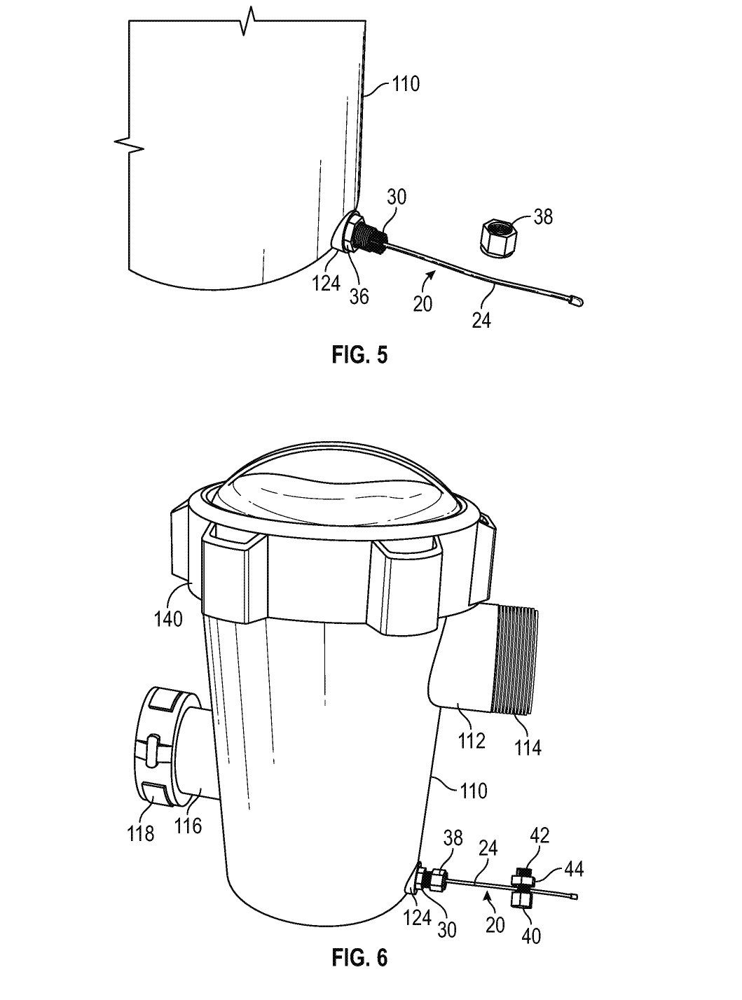

FIG. 5 is a perspective view of a portion of the housing 110 illustrated in FIG. 4, with an additional portion of the retrofit kit 10 of FIG. 1 installed. As illustrated in FIG. 5, the cap 38 of the strain relief fitting 30 has been removed from the strain relief fitting 30. The strain relief fitting 30 has also been placed on the extension portion 24 of the bonding conductor 20, by inserting the extension portion 24 of the bonding conductor 20 through the hollow body of the strain relief fitting 30.

FIG. 5 also illustrates that the strain relief fitting 30 has been inserted into the drain hole 124 of the housing 110. In the embodiment illustrated in FIG. 5, the strain relief fitting 30 is dimensioned such that the outer surface of the strain relief fitting 30 engages with the inner surface of the drain hole 124. Additionally, in the embodiment illustrated in FIG. 5, the threaded outer surface 34 of the strain relief fitting 30 (see FIGS. 1-2) engages with threads on the inner surface of the drain hole 124 in order to secure the strain relief fitting 30 into place. The connector nut 36 of the illustrated strain relief fitting 30 is formed onto the outer surface of the strain relief fitting 30 and is dimensioned so as to be larger in diameter than the opening of the drain hole 124. In this manner, the connector nut 36 may be engaged to tighten the threads of the strain relief fitting 30 with the drain hole 124, and also to ensure that water does not leak out of the drain hole 124 while the strain relief fitting 30 is engaged in the drain hole 124.

In other embodiments, a gasket or O-ring (not shown) may be inserted between the drain hole 124 and the connector nut 36 in order to assist with providing a watertight seal when the strain relief fitting 30 is engaged in the drain hole 124. Similarly, in other embodiments the connector nut 36 may not be integrally formed on the strain relief fitting 30. In such embodiments, the connector nut 36 may be a separate component that engages the outer surface of the strain relief fitting 30 and/or engages a surface of the drain hole 124 in order to assist with securing the strain relief fitting 30 into the drain hole 124.

FIG. 6 is a side view of the exemplary pump trap 100 of FIG. 3 with the exemplary retrofit kit 10 of FIG. 1 installed. As illustrated in FIG. 6, the cap 38 has been attached to the strain relief fitting 30 by inserting the extension portion 24 of the bonding conductor 20 through the cap 38 and screwing the cap 38 onto a threaded portion 34 on the outer surface of the strain relief fitting 30. Additionally, the split bolt connector 40 has been attached to the extension portion 24 of the bonding conductor 20 by inserting the extension portion 24 of the bonding conductor 20 into the split in the split bolt connector 40. The nut portion 44 has been engaged with the threaded outer surface 42 of the split bolt connector 40 to hold the connector 40 into place on the extension portion 24. Additionally, the strainer basket 130 has been inserted into the housing 110 and the lid 140 has been affixed to cover the opening in the top of the housing 110, and to hold the strainer basket 130 in place.

With the retrofit kit 10 installed in the pump trap 100, the pump trap 100 can be re-installed inline between the pump and the pool using the pump connector port 116 and pipe connector port 112, respectively. A wire or line from the pool grounding or bonding system may then be attached to the split bolt connector 40 (or in some embodiments directly to the extension portion 24 of the bonding conductor 20). In this manner, the retrofit kit 10 allows the pump trap to be adapted such that the water inside can be bonded in accordance with the applicable electrical codes (including the NEC) without the need for purchasing a new pump and/or pump trap.

Although selected aspects of the exemplary retrofit kit 10 and exemplary pump trap 100 have been illustrated and described, it will be understood that various substitutions and alterations may be made to the retrofit kit 10 and/or the pump trap 100 without departing from the spirit and scope of the present invention. For example, it is anticipated that the retrofit kit 10 and/or the components thereof may be sized and/or dimensioned to work with any size, shape, or dimension of pump trap 100, or with any other component in which equipotential bonding is desired, such as, but not limited to, skimmers, plumbing fixtures, pump traps, valves, drains, etc. Similarly, although the body portion 22 of the bonding conductor 20 is illustrated as a round coil, it is envisioned that the body portion 22 may be any shape or size desired. For instance, the bonding conductor 20 may be a straight length of flexible conducting material that can be shaped at installation into any shape, dimension or configuration desired to work with the pump trap 100 or other component with which the retrofit kit 10 intended to be used.

The above detailed description of the embodiments, and the examples, are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

### LIST OF REFERENCE NUMERALS

10 retrofit kit, invention, device
20 bonding conductor
22 body portion of bonding conductor
24 extension portion of bonding conductor
30 strain relief fitting
32 top opening of strain relief fitting
34 threaded portion of strain relief fitting
36 connector nut of strain relief fitting
38 hollow cap of strain relief fitting
40 split bolt connector
42 body portion of split bolt connector
44 nut portion of split bolt connector
100 pump trap
110 housing of pump trap
112 pipe connector port
114 threaded portion of housing of pump trap
116 pump connector port
118 connector fitting of housing of pump trap
120 top opening of pump trap
122 threaded surface of housing of pump trap
124 drain hole
130 strainer basket
132 inlet opening of strainer basket
140 lid

What is claimed is:

1. A retrofit kit for use with a water-holding structure, the kit comprising:
a) a bonding conductor, the bonding conductor including:
i) a body portion configured to reside within a component attached to the water-holding structure, and
ii) an extension portion configured to extend outwardly from an outer surface of the component attached to the water-holding structure;
b) a strain relief fitting configured to receive the extension portion of the bonding conductor and to couple to the component attached to the water-holding structure; and
c) a conductor fitting configured to attach to the extension portion of the bonding conductor and to attach to a conductive system for the water-holding structure, providing an electrical connection between the bonding conductor and the conductive system of the water-holding structure, or the water therein,
wherein the bonding conductor provides equipotential bonding for the water therein.

2. The retrofit kit of claim 1, wherein the body portion of the bonding conductor has a conductive surface area of at least nine square inches.

3. The retrofit kit of claim 1, wherein the component attached to the water-holding structure comprises a pump trap.

4. The retrofit kit of claim 3, wherein the extension portion of the bonding conductor is further configured to extend through a drain hole in a housing of the pump trap.

5. The retrofit kit of claim 4, wherein the strain relief fitting further includes an outer surface with a threaded portion, the threaded portion configured to engage an inner surface of the drain hole.

6. The retrofit kit of claim 5, wherein the strain relief fitting further includes a cap portion configured to engage an end of the strain relief fitting that is distal from drain hole, the cap portion configured to provide strain relief for the extension portion of the bonding conductor.

7. The retrofit kit of claim 3, wherein the pump trap includes a cylindrical housing and wherein the body portion of the bonding conductor is configured to fit within an inner surface of the cylindrical housing of the pump trap.

8. The retrofit kit of claim 7, wherein the body portion of the bonding conductor comprises a round coil of conductive wire.

9. The retrofit kit of claim 1, wherein the conductor fitting comprises a split bolt connected attached to the extension portion of the bonding conductor.

10. A system for providing equipotential bonding, the system comprising:
a) a water-holding structure, the water-holding structure including at least one conductive portion;
b) a pool component coupled to the water-holding structure; and
c) a retrofit kit for use with the pool component, the retrofit kit comprising:
i) a bonding conductor, the bonding conductor including a body portion configured to reside within the water-holding structure and an extension portion configured to extend outwardly from an outer surface of the component, and
ii) a strain relief fitting configured to receive the extension portion of the bonding conductor and to couple to the water-holding structure component, and
wherein the extension portion of the bonding conductor is further configured to electrically couple with the water-holding structure conductive portion and provide equipotential bonding to the water therein.

11. The system of claim 10, wherein the body portion of the bonding conductor has a conductive surface area of at least nine square inches.

12. The system of claim 11, wherein the water-holding structure component comprises a pump trap.

13. The system of claim 12, wherein the extension portion of the bonding conductor is further configured to extend through a drain hole in a housing of the pump trap.

14. The system of claim 13, wherein the strain relief fitting further includes an outer surface with a threaded portion, the threaded portion configured to engage an inner surface of the drain hole.

15. The system of claim 14, wherein the strain relief fitting further includes a cap portion configured to engage an end of the strain relief fitting that is distal from drain hole, the cap portion configured to provide strain relief for the extension portion of the bonding conductor.

16. The system of claim 12, wherein the pump trap includes a cylindrical housing and wherein the body portion of the bonding conductor is configured to fit within an inner surface of the cylindrical housing of the pump trap.

17. The system of claim 16, wherein the body portion of the bonding conductor comprises a round coil of conductive wire.

18. The system of claim 1, wherein the retrofit kit further comprises a conductor fitting configured to attach to the extension portion of the bonding conductor and to attach to the pool conductive portion, so as to provide an electrical coupling between the bonding conductor and the pool conductive portion.
